(19) United States
(12) Patent Application Publication
(10) Pub. No.: US 2026/0280827 A1
(43) Pub. Date: Sep. 17, 2026

(54) RESOURCE BLOCKS DETERMINATION FOR TRANSMISSIONS

(71) Applicant: Nokia Technologies Oy, Espoo (FI)

(72) Inventors: Guillermo POCOVI, Aalborg (DK); Claudio ROSA, Randers NV (DK); Erika PORTELA LOPES DE ALMEIDA, Aalborg (DK); Nhat-Quang NHAN, Reims (FR); Youngsoo YUK, Seoul (KR); Jing Yuan SUN, Beijing (CN); Klaus HUGL, Vienna (AT)

(73) Assignee: Nokia Technologies Oy, Espoo (FI)

(21) Appl. No.: 19/473,204

(22) PCT Filed: Apr. 7, 2023
(86) PCT No.: PCT/CN2023/087141

§ 371 Date: Oct. 7, 2025

(51) Int. Cl. H04L 5/00; H04W 72/1263

(52) U.S. Cl. CPC H04L 5/0094; H04W 72/1263

(57) ABSTRACT

Embodiments relate to resource blocks determination. In an aspect, a terminal device receives, from a network device, scheduling information for scheduling information for a downlink (DL) or an uplink (UL) transmission indicating a plurality of consecutive resource blocks (RBs) in a time unit during which at least one forbidden subband is configured for the transmission. The terminal device compares a position of at least one of an initial RB and a last RB among the plurality of consecutive RBs and a position of the at least one forbidden subband. The terminal device receives the DL transmission from the network device or transmits the UL transmission to the network device using a set of RBs determined based on the comparison. The embodiments of the present disclosure can allow to indicate to a terminal device whether or not to allocate DL/UL RBs within the UL/DL subbands and guardbands, without additional overhead.

### FIELD

Various example embodiments generally relate to the field of communication, and in particular, to a terminal device, a network device, methods, apparatuses and a computer readable storage medium for resource blocks determination for transmissions.

### BACKGROUND

With the development of communication technology, duplexing evolution including subband non-overlapping full duplex (SBFD) has been studied in a third generation partnership project (3GPP) release 18 (Rel-18) study item (SI). Currently, 3GPP 5G NR supports two duplexing modes. One duplexing mode is frequency division dual (FDD) for paired bands and another duplexing mode is time division dual (TDD) for unpaired bands. In TDD, the time domain resource is split between downlink and uplink. Allocation of a limited time duration for the uplink in TDD would result in reduced coverage, increased latency, and reduced capacity.

### SUMMARY

In general, example embodiments of the present disclosure provide a terminal device, a network device, methods, apparatuses and a computer readable storage medium for resource blocks determination for transmissions. For example, the solution provided by the example embodiments of the present disclosure can allow to indicate to a terminal device whether or not to allocate downlink (DL) RB(s) within the uplink (UL) subband and guardband(s), without additional overhead, or allow to indicate to a terminal device whether or not to allocate UL RBs within the DL subband and guardband(s), without additional overhead.

In a first aspect, there is provided a terminal device. The terminal device may comprise at least one processor; and at least one memory storing instructions that, when executed by the at least one processor, cause the terminal device at least to: receive, from a network device, scheduling information for a DL or an UL transmission indicating a plurality of consecutive RBs in a time unit during which at least one forbidden subband is configured for the transmission; compare a position of at least one of an initial RB and a last RB among the plurality of consecutive RBs and a position of the at least one forbidden subband; and receive the DL transmission from the network device or transmit the UL transmission to the network device using a set of RBs determined based on the comparison.

In a second aspect, there is provided a network device. The network device may comprise at least one processor; and at least one memory storing instructions that, when executed by the at least one processor, cause the network device at least to: transmit, to a network device, scheduling information for a DL or a UL transmission indicating a plurality of consecutive RBs in a time unit during which at least one forbidden subband is configured for the transmission; compare a position of at least one of an initial RB and a last RB among the plurality of consecutive RBs and a position of the at least one forbidden subband; and transmit the DL transmission to the terminal device or receive the UL transmission from the terminal device using a set of RBs determined based on the comparison.

In a third aspect, there is provided a method. The method may comprise: receiving, at a terminal device and from a network device, scheduling information for a DL or a UL transmission indicating a plurality of consecutive RBs in a time unit during which at least one forbidden subband is configured for the transmission; comparing, at the terminal device, a position of at least one of an initial RB and a last RB among the plurality of consecutive RBs and a position of the at least one forbidden subband; and receiving the DL transmission from the network device or transmitting the UL transmission to the network device using a set of RBs determined based on the comparison.

In a fourth aspect, there is provided a method. The method may comprise: transmitting, at a network device and to a terminal device, scheduling information for a DL or a UL transmission indicating a plurality of consecutive RBs in a time unit during which at least one forbidden subband is configured for the transmission; comparing, at the network device, a position of at least one of an initial RB and a last RB among the plurality of consecutive RBs and a position of the at least one forbidden subband; and transmitting the DL transmission to the terminal device or receiving the UL transmission from the terminal device using a set of RBs determined based on the comparison.

In a fifth aspect, there is provided an apparatus. The apparatus may comprise: means for receiving, at a terminal device and from a network device, scheduling information for a DL or a UL transmission indicating a plurality of consecutive RBs in a time unit during which at least one forbidden subband is configured for the transmission; means for comparing a position of at least one of an initial RB and a last RB among the plurality of consecutive RBs and a position of the at least one forbidden subband; and means for receiving the DL transmission from the network device or transmitting the UL transmission to the network device using a set of RBs determined based on the comparison.

In a sixth aspect, there is provided an apparatus. The apparatus may comprise: means for transmitting, at a network device and to a terminal device, scheduling information for a DL or a UL transmission indicating a plurality of consecutive RBs in a time unit during which at least one forbidden subband is configured for the transmission; means for comparing a position of at least one of an initial RB and a last RB among the plurality of consecutive RBs and a position of the at least one forbidden subband; and means for transmitting the DL transmission to the terminal device or receiving the UL transmission from the terminal device using a set of RBs determined based on the comparison.

In a seventh aspect, there is provided a non-transitory computer readable medium comprising program instructions for causing an apparatus to perform at least the method according to the third or fourth aspect.

In an eighth aspect, there is provided a computer program comprising instructions, which, when executed by an apparatus, cause the apparatus at least to: receive, from a network device, scheduling information for a DL or a UL transmission indicating a plurality of consecutive RBs in a time unit during which at least one forbidden subband is configured for the transmission; compare a position of at least one of an initial RB and a last RB among the plurality of consecutive RBs and a position of the at least one forbidden subband; and receive the DL transmission from the network device or transmit the UL transmission to the network device using a set of RBs determined based on the comparison.

In a ninth aspect, there is provided a computer program comprising instructions, which, when executed by an apparatus, cause the apparatus at least to: transmit, to a network device, scheduling information for a DL or a UL transmission indicating a plurality of consecutive RBs in a time unit during which at least one forbidden subband is configured for the transmission; compare a position of at least one of an initial RB and a last RB among the plurality of consecutive RBs and a position of the at least one forbidden subband; and transmit the DL transmission to the terminal device or receive the UL transmission from the terminal device using a set of RBs determined based on the comparison.

In a tenth aspect, there is provided a terminal device. The terminal device may comprise a receiving circuitry configured to receive, from a network device, scheduling information for a DL or a UL transmission indicating a plurality of consecutive RBs in a time unit during which at least one forbidden subband is configured for the transmission; a comparing circuitry configured to compare a position of at least one of an initial RB and a last RB among the plurality of consecutive RBs and a position of the at least one forbidden subband; and a transmitting/receiving circuitry configured to receive the DL transmission from the network device or transmit the UL transmission to the network device using a set of RBs determined based on the comparison.

In an eleventh aspect, there is provided a network device. The network device may comprise a transmitting circuitry configured to transmit, to a network device, scheduling information for a DL or a UL transmission indicating a plurality of consecutive RBs in a time unit during which at least one forbidden subband is configured for the transmission; a comparing circuitry configured to compare a position of at least one of an initial RB and a last RB among the plurality of consecutive RBs and a position of the at least one forbidden subband; a transmitting/receiving circuitry configured to transmit the DL transmission to the terminal device or receive the UL transmission from the terminal device using a set of RBs determined based on the comparison.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example network environment in which example embodiments of the present disclosure may be implemented;

FIGS. 1B-1D illustrate example illustrations of frequency-time resource partitioning and time-time resource partitioning related to some embodiments of the present disclosure;

FIG. 1E illustrates an example illustration of SBFD and non-SBFD slots related to some embodiments of the present disclosure;

FIG. 1F illustrates an example illustration of unaligned boundaries between resource block groups (RBGs) and subbands in accordance with some embodiments of the present disclosure;

FIG. 1G illustrates an example illustration of rate matching in SBFD slots in accordance with some example embodiments of the present disclosure;

FIG. 2 illustrates an example signaling process for determining resource blocks for transmissions in accordance with some example embodiments of the present disclosure;

FIG. 3 illustrates an example flowchart of a process of determining resource blocks in accordance with some example embodiments of the present disclosure;

FIGS. 4A-4D illustrate examples illustrations of determined resource blocks in accordance with some example embodiments of the present disclosure;

FIG. 5 illustrates another example flowchart of a process of determining resource blocks in accordance with some example embodiments of the present disclosure;

FIGS. 6A-6B illustrate other examples illustrations of determined resource blocks in accordance with some example embodiments of the present disclosure;

FIG. 7 illustrates further example flowchart of a process of determining resource blocks in accordance with some example embodiments of the present disclosure;

FIG. 8 illustrates further examples illustrations of determined resource blocks in accordance with some example embodiments of the present disclosure;

FIG. 9 illustrates an example flowchart of a method implemented at a terminal device in accordance with some example embodiments of the present disclosure;

FIG. 10 illustrates an example flowchart of a method implemented at a network device in accordance with some example embodiments of the present disclosure;

FIG. 11 illustrates an example simplified block diagram of a device that is suitable for implementing embodiments of the present disclosure; and

FIG. 12 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block” (RB), “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, 3GPP supports two duplexing modes, which are FDD mode and TDD mode. Allocation of a limited time duration for the uplink in TDD would result in reduced coverage, increased latency, and reduced capacity. Therefore, 3GPP has agreed to initiate a Rel-18 study item (RP-213591) on the evolution of duplexing operation in NR. One of the objectives of the study item is to allow simultaneous DL and UL transmission on different physical RBs or subbands within an unpaired wideband NR cell. In the present disclosure, this duplexing scheme is referred to subband non-overlapping full duplex (SBFD). In other sources, this duplexing scheme is also referred to as cross division duplexing (xDD) scheme or flexible division duplexing (FDU).

For better understanding the present disclosure, some of the relevant objectives of the study item (RP-213591) in the study item description are shown in Table 1.

```
TABLE 1
In this study, the followings are assumed:
  Duplex enhancement at the gNB side
  Half duplex operation at the UE side
  No restriction on frequency ranges
The detailed objectives are as follows:
  (. . .)
  Study the subband non-overlapping full duplex and potential enhancements on
  dynamic/flexible TDD (RAN1, RAN4).
    Identify possible schemes and evaluate their feasibility and performances (RAN1).
    Study inter-gNB and inter-UE CLI handling and identify solutions to manage them
    (RAN1).
    Consider intra-subband CLI and inter-subband CLI in case of the subband
    non-overlapping full duplex.
    Study the performance of the identified schemes as well as the impact on legacy operation
    assuming their co-existence in co-channel and adjacent channels (RAN1).
    Study the feasibility of and impact on RF requirements considering adjacent-channel
    co-existence with the legacy operation (RAN4).
    Study the feasibility of and impact on RF requirements considering the self-interference,
    the inter-subband CLI, and the inter-operator CLI at gNB and the inter-subband CLI and
    inter-operator CLI at UE (RAN4).
    (. . .)
```

From table 1 and description of SBFD operation, it can be observed that there are two slot types for both DL and UL transmissions. One of the two slot types is SBFD slots, during which the non-overlapping DL subbands and UL subband(s) both exist. Another of the two slot types is non-SBFD slots, during which the entire band is used for either DL or UL, for example, legacy or full DL slots, or legacy or full UL slots.

In SBFD slots, a guardband is expected to be placed between DL and UL RBs. This provides better isolation between UL and DL transmissions and is expected to be essential for reducing the impact of the self-interference. A reason may be that a gNB's own DL transmissions and the gNB's own UL reception. It also reduces the impact of the cross-link interference (CLI) between UE to UE links, and gNB to gNB links.

In recent 3GPP discussions regarding DL, UL subband and guardband indication, several SBFD operation modes have been studied including whether time and frequency locations of subbands for SBFD operation are known to the SBFD-aware UE or not. However, it has been agreed in 3GPP RAN1 #110 meeting that at least the operation mode with time and frequency locations of subbands for SBFD operation being known to the SBFD-aware UE is prioritized. For example, the following agreement was reached in RAN1 #111 meeting as shown in table 2.

```
TABLE 2
  Agreement
  For a SBFD aware UE semi-statically configured with UL subband in a SBFD symbol configured
as DL in TDD-UL-DL-ConfigCommon, the following is agreed as baseline in the RAN1 study:
    UL transmissions within UL subband are allowed in the symbol
    UL transmissions outside UL subband are not allowed in the symbol
    Frequency locations of DL subband(s) are known to the SBFD aware UE
    The frequency location of DL subband(s) can be explicitly indicated or implicitly derived
    DL receptions within DL subband(s) are allowed in the symbol
    Note: UL transmissions are within active UL BWP and DL receptions are within active DL BWP in
    the symbol
```

In addition to indicating the UE the frequency locations of DL subband(s), there is a need that the UE has knowledge of the location of the UL subband(s) as well as the location of the guardband(s). In principle, two out of the three among DL subband, UL subband, guardband, can be signaled to the UE, while the remaining one can be implicitly derived by the UE.

In the above agreement shown in table 2, another point of discussion is whether UL and DL transmissions are allowed outside the UL and DL subband, respectively. While the former case (UL transmissions outside UL subband) is not allowed in the above agreement (at least for symbols configured as DL in TDD-UL-DL-ConfigCommon), it is believed that it should be possible to have DL transmissions outside the DL subband, for example, to improve DL performance in case there is momentarily not much UL traffic to serve or to facilitate operation with legacy UEs which are not aware of the presence of an UL subband in DL symbols (as per TDD-UL-DL-ConfigCommon). For instance, an SBFD symbol could be converted into a DL-only symbol, so that the gNB can dynamically adapt the configuration to traffic conditions.

In RAN1 #111, the following agreement shown in table 3 was reached for SBFD symbols configured in flexible symbols.

```
TABLE 3
  Agreement
  For SBFD operation in a symbol configured as flexible in TDD-UL-DL-ConfigCommon, study
  the following options for SBFD aware UEs,
  Option 1:
    UL transmissions within UL subband are allowed in the symbol
    UL transmissions outside UL subband are not allowed in the symbol
    Frequency locations of DL subband(s) are known to the SBFD aware UE
    DL receptions within DL subband(s) are allowed in the symbol
    FFS: Whether DL receptions outside DL subband(s) are allowed or not in the symbol
    Option 2:
    UL transmissions within UL subband are allowed in the symbol
    The RBs outside the UL subband can be used as either UL, or DL excluding guardband(s) if
    used, in the symbol from gNB's perspective, and the transmission direction for all those RBs is
    the same
      FFS: SBFD aware UE behaviours
      FFS: Whether or not signalling of guardband(s) is needed
    FFS: Whether or not the symbol can be converted to a DL-only symbol
    Frequency locations of DL subband(s) are known to the SBFD aware UE
    DL receptions within DL subband(s) are allowed in the symbol
  Note: UL transmissions are within active UL BWP and DL receptions are within active DL BWP
  in the symbol for both options. For all RBs outside the UL subband, UE cannot use separate RBs
  for DL and UL simultaneously
```

As shown in table 3, for SBFD operation in symbols configured as flexible, there is no decision yet on whether UL transmissions outside the UL subband are possible (option 2). It is also discussed whether to allow the flexible symbol to be converted to full-UL or full-DL.

Regarding the indication of resource blocks for PDSCH and physical uplink shared channel (PUSCH) allocations, the 5G NR supports two frequency-domain resource allocation (RA) types applicable to both PDSCH and PUSCH resource allocation in frequency domain namely Resource Allocation (RA) Type 0 and Resource Allocation (RA) Type 1. RA type 0 as described in technical specification (TS) 38.214, Sec 5.1.2.1 and 6.1.2.1 is a bitmap based resource allocation, and RA type 1 as described in technical specification (TS) 38.214, Sec 5.1.2.2 and 6.1.2.2 is consecutive RBs are allocated to the UE by indicating the start RB and number of RBs.

For PDSCH resource allocation (RA) type 0, the resource blocks are allocated with a resolution of one resource block group (RBG). There are currently two RBG sizes defined for each BWP size range, as defined in TS 38.214, but can be as large as 16 RBs for BWPs larger than 145 RBs.

For SBFD, the coarse scheduling granularity may result in unaligned boundaries between the RBGs and the DL, guardband or UL subband(s) which makes it difficult for the resource allocation decisions at the gNB. This problem is under study in 3GPP as noted in the following agreement in table 4.

```
TABLE 4
Agreement
Study the impact and benefits of potential enhancements to resource allocation in
frequency-domain for SBFD operation, considering unaligned boundaries between resource
block group(s)/reporting subband(s) and SBFD subbands, including at least the following:
  RBG for PDSCH RA type 0
  CSI reporting configuration
  CSI-RS resource configuration
  PRG of PDSCH
```

Regarding RBG for PDSCH RA type 0, for a downlink RBGs allocation, if the DL subband allocation granularity and RBGs are aligned, DL PDSCH allocations can be scheduled without any problem. However, if the borders of the RBGs are not aligned with the UL subband, RBs in the UL subband could not be used for UL transmissions (as they collide with the guardband). If the RBG is placed outside DL subband, there is a waste of RBs in both UL and DL direction. Furthermore, this problem still exists even if there is no guardband known to the UE (i.e. UL and DL subbands are contiguous at least from UE's perspective).

Another issue is being discussed in RAN1 regarding the RA Type 1, in which a contiguous frequency allocation is given by a start RB and a number of RBs. Currently, non-contiguous allocation in RA type 1 is not allowed, and different options have been discussed in RAN1 meetings for RA type 1 if SBFD operation is configured with two DL subbands in the borders of the BWP, and one UL subband in the center of the BWP (DUD).

As in the RA type 0 discussion, rate matching is being proposed for the RA type 1. Another option is to assume a “mirror image” allocation in the DL subbands, in which the frequency resource allocation in one subband is mirrored into the other. In a rate matching approach, and for RA type 1, the gNB indicates the frequency domain resource allocation (FDRA) by a resource indicator value (RIV) [6, TS 38.214], which indicates a starting RB and a number of allocated RBs. For example, the start RB is indicated by S and the size of the allocation is indicated by N. For the DL transmission, if some RBs indexes overlap with the forbidden subbands (UL and guard bands), the UE combines the initial DL allocation with the knowledge of the location of the guardbands, UL subband and DL subbands to derive the available resources and the final allocation.

Considering the UE is aware of the locations of the DL, UL and the guardband, a rate matching can be performed to exclude the invalid RBs of the corresponding allocation. However, there is a need that allowing DL transmissions outside the DL subband in the absence of UL traffic. If there is no UL transmission at all in a slot, there is no big reason to keep the RBs in the guardband unused, as there is no self-interference problem nor gNB-gNB CLI problem if some sort of coordination is assumed between cells or sectors.

Therefore, at least for a PDSCH/PUSCH scheduled with resource allocation Type 1, there is a need to indicate to the UE whether to consider or not consider RBs outside the DL or UL subbands as part of the PDSCH/PUSCH allocation.

Example embodiments of the present disclosure provide a solution for determining resource blocks for transmissions. According to embodiments of the present disclosure, a terminal device receives, from a network device, scheduling information for a DL transmission or a UL transmission on a plurality of RBs in a time unit during which at least one DL subband and at least one UL subband are configured. The terminal device further compares at least one position of the plurality of RBs with a position of the at least one DL subband or a position of the at least one UL subband. The terminal device further transmits the UL transmission or receives the DL transmission based on the comparison. It is understood that the above procedure steps may work together, in a flow of operations as described in the next section, partly together or independently of each other.

The example embodiments for determining resource blocks for transmissions as provided in the present disclosure can allow to indicate to a terminal device whether or not to allocate downlink (DL) RB(s) within the uplink (UL) subband and guardband(s), without additional overhead, or allow to indicate to a terminal device whether or not to allocate UL within the DL subband and guardband(s), without additional overhead. Principles and some example embodiments of the present disclosure will be described in detail below with reference to the accompanying drawings.

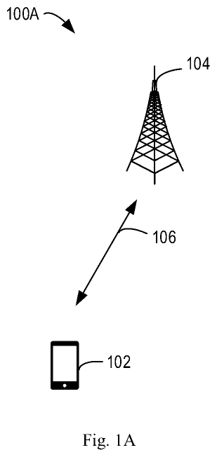

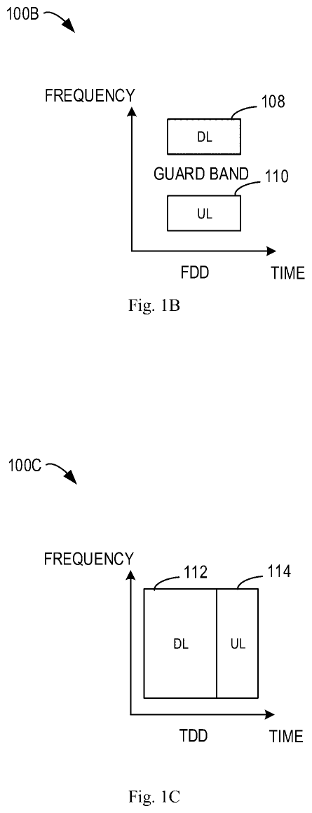

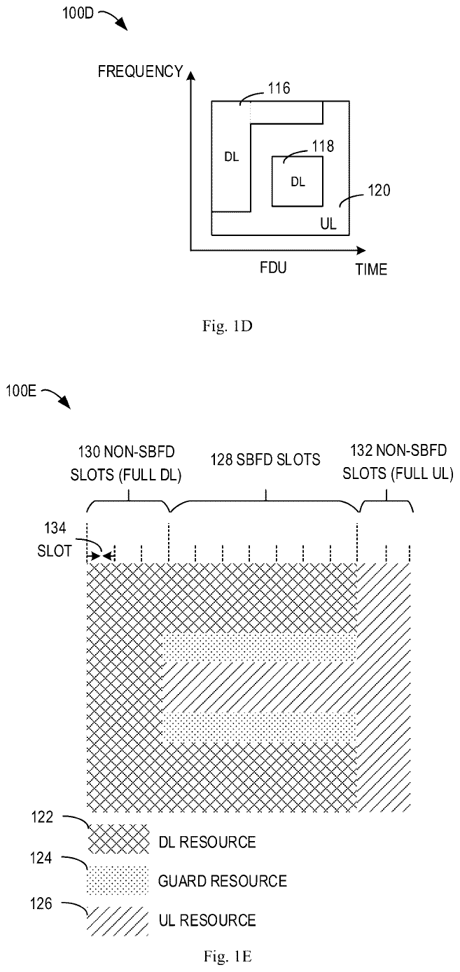

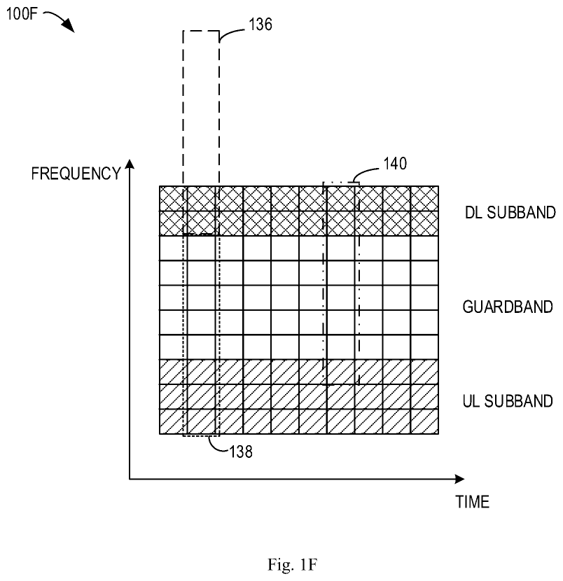

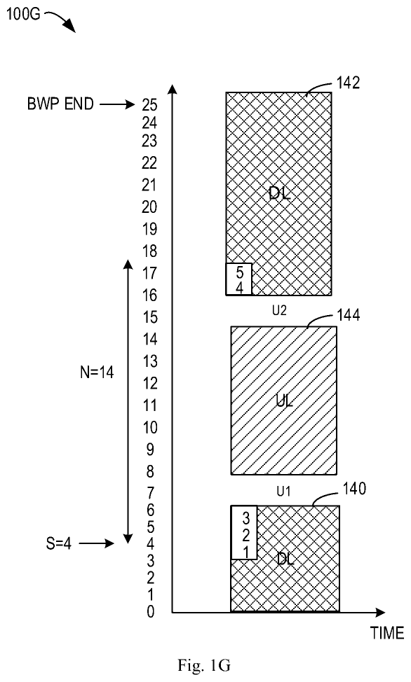

For illustrative purposes, principle and example embodiments of the present disclosure for determining resource blocks for transmissions will be described below with reference to FIG. 1A-FIG. 12. However, it is to be noted that these embodiments are given to enable the skilled in the art to understand inventive concepts of the present disclosure and implement the solution as proposed herein, and not intended to limit scope of the present application in any way.

Reference is made to FIG. 1A, which illustrates an example network environment 100A in which example embodiments of the present disclosure may be implemented. The network environment 100A, which may be a part of a communication network, includes a terminal device 102 and a network device 104.

As illustrated in FIG. 1A, the terminal device 102 may also be referred as a user equipment 102 or a UE 102. The network device 104 may also be referred as a gNB 104. The terminal device 102 and the network device 104 can communicate (106) with each other. The terminal device 102 may receive resource allocation type 0 or resource allocation type 1 from the network device 104. For type 0, the resource blocks are allocated with a resolution of one resource block group (RBG). For example, a RBG may comprise eight RBs. For type 1, contiguous frequency allocation is given by a start RB and a number of RBs. For example, for a PDSCH resource allocation, an initial RB may be the lowest allocated RB or the lowest RB in the DL subband and number of RBs may be eight.

Reference is made to FIGS. 1B-1D, which illustrate example illustrations of frequency-time resource partitioning and time-time resource partitioning related to some embodiments of the present disclosure. FIG. 1B shows an illustration 100B of FDD. In FDD, there are paired bands such as DL band 108 and UL band 110. In frequency domain, the DL band 108 and UL band 110 are split by a guard band.

FIG. 1C shows an illustration 100C of TDD. In TDD, the time domain resource is split between downlink 112 and uplink 114. It can be seen that the uplink 112 has a shorter length than the downlink 114. Allocation of a limited time duration for the uplink in TDD would result in reduced coverage, increased latency, and reduced capacity.

FIG. 1D shows an illustration 100D of FDU. In FDU, it is allowed that simultaneous DL and UL transmission on different RBs or subbands within an unpaired wideband NR cell. For example, DL 116, DL 118 and UL 120 are allowed to simultaneously duplexing.

Reference is made to FIG. 1E, which illustrates an example illustration 100E of SBFD and non-SBFD slots related to some embodiments of the present disclosure. As illustrated in FIG. 1E, legend 122 represents a DL resource. Legend 124 represents a guard resource. Legend 128 represents a UL resource. In SBFD slots 128, the non-overlapping DL subbands and UL subband(s) both exist. In non-SBFD slots 130, the entire band is used for DL. In non-SBFD slots 132, the entire band is used for UL. SBFD slots or non-SBFD slots may comprise a same or different number of slots.

Reference is made to FIG. 1F, which illustrates an example illustration 100F of unaligned boundaries between RBGs and subbands in accordance with some embodiments of the present disclosure. As illustrated in FIG. 1F. For example, a guardband has a size of 5 RBs while the RBG has a size of 8 RBs. If the guardband and RBGs are aligned as shown in block 136 and block 138, DL PDSCH allocations can be scheduled without any problem, while 3 RBs in the UL subband could not be used for UL transmissions (as they collide with the guardband). If the RBG is placed as illustrated with block 140, there is a waste of RBs in both UL and DL direction.

FIG. 1G illustrates an example illustration 100G of rate matching in SBFD slots in accordance with some example embodiments of the present disclosure. As shown in FIG. 1G, the start RB is indicated by S and S is equal to 4 and the size of the allocation of RBs is indicated by N, where N is 14. RBs indexes from 7 to 15 are overlapping with the forbidden subbands (UL 144 and guard bands U1 and U2). The first RB of the forbidden subband (index 7) is indicated as U1, and the last RB (index 15) as U2. A UE may combine the initial DL allocation with the knowledge of the location of the guardbands, UL subband 144 and DL subbands 142 to derive the available resources and the final allocation. In this example, the final allocation consists of N+(U2−U1+1)=5 RBs. Thus, for example, a rate matching may be needed for this case. As another example which will be described hereafter, the UE may consider or not consider RBs outside the DL subband as part of the PDSCH allocation.

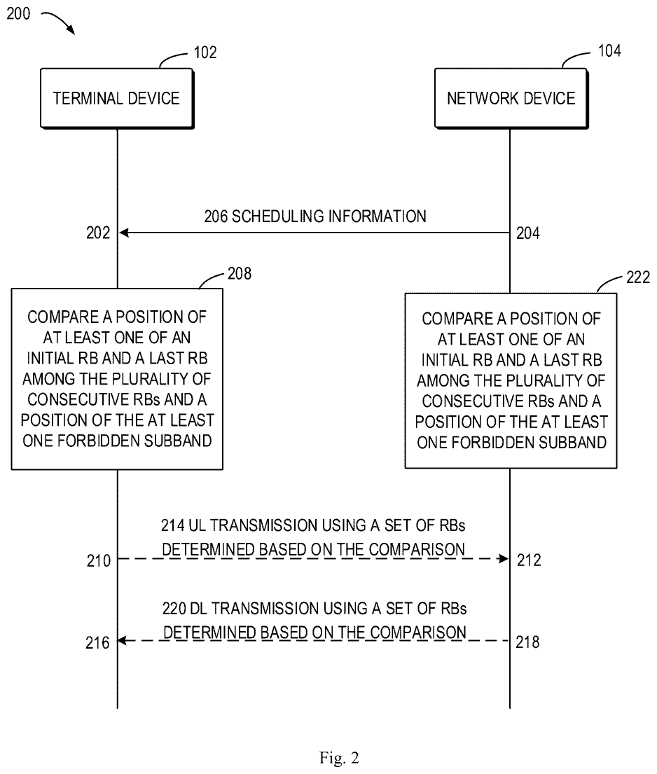

Reference is made to FIG. 2, which illustrates an example signaling process 200 for determining resource blocks for transmissions in accordance with some example embodiments of the present disclosure. As shown, the network device 104 transmits (204) scheduling information (206) to the terminal device 102. The scheduling information (206) is for a DL transmission or a UL transmission, and indicates a plurality of consecutive RBs in a time unit.

The time unit may comprise a slot or symbol. During the time unit, at least one forbidden subband is configured for the transmission. For example, in a manner of RA type 1 and for a DL transmission, a forbidden subband may be used to indicate both the UL subband and the guardband. For another example, in the manner of RA type 1 and for a UL transmission, a forbidden subband may be used to indicate both the DL subband and the guardband.

In the manner of RA type 1, consecutive RBs are allocated to the terminal device 102 by indicating an initial RB and number of RBs. For example, let S represent the position of the initial RB, and let N represent the number of RBs. The consecutive RBs can be inferred from S and N. For example, a position of the last RB among the consecutive RBs can be determined as S+N−1.

The terminal device 102 receives (202) the scheduling information (206) from the network device 104. The terminal device 102 compares (208) a position of at least one of an initial RB and a last RB among the plurality of consecutive RBs and a position of the at least one forbidden subband.

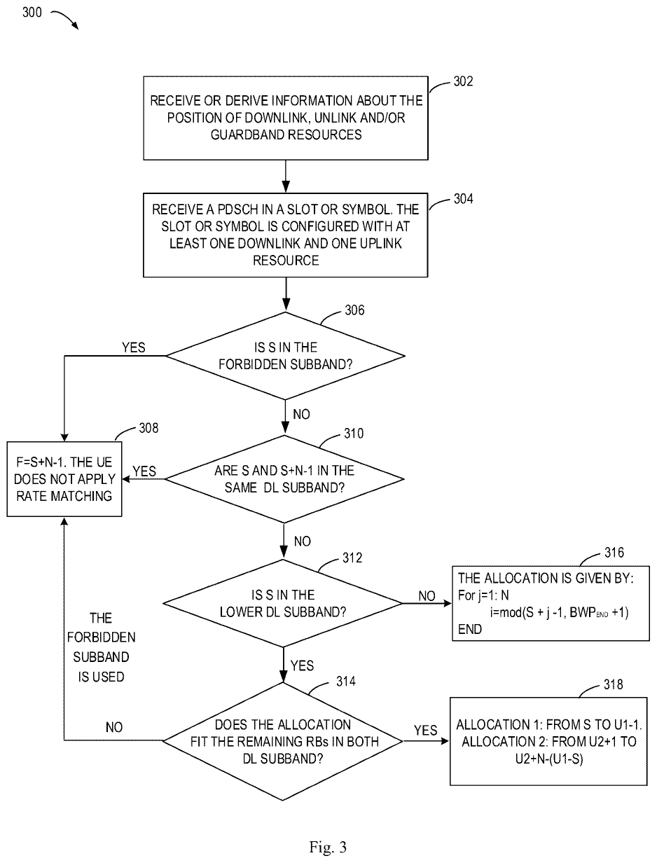

As an example, for a PDSCH transmission, the terminal device 102 may compare if both of initial RB S or last RB S+N−1 are in the forbidden subband. As another example, the terminal device 102 may compare if either of S or S+N−1 are in the forbidden subband. As yet another example, for a PUSCH transmission, the terminal device 102 may compare if both of S or S+N−1 are in the DL subband. As a further example, the terminal device 102 may compare if either of S or S+N−1 are in a same subband. It is to be understood there are other comparison procedures, and will be described with FIGS. 3-8 accordingly.

The network device 104 compares (222) a position of at least one of an initial RB and a last RB among the plurality of consecutive RBs and a position of the at least one forbidden subband. The comparison (222) logics for both PDSCH and PUSCH transmission are similar as described with the comparison block (208), and will be described with FIGS. 3-8 as well.

In some example embodiments, the scheduling information (206) is for a UL transmission, the terminal device 102 transmits (210) the UL transmission (214) to the network device 104 based on the comparison (208). The network device 104 receives (212) the UL transmission (214) from the terminal device 102.

In some example embodiments, the scheduling information (206) is for a DL transmission, the network device 104 transmits (218) the DL transmission (220) from the terminal device 102. The terminal device 102 receives (216) the DL transmission (220) from the network device 104 based on the comparison (208).

By implementing FIG. 2, it can allow to indicate to a terminal device whether or not to allocate DL RBs within the UL subband and guardband(s), without additional overhead, or allow to indicate to a terminal device whether or not to allocate UL RBs within the DL subband and guardband(s), without additional overhead.

Reference is made to FIG. 3, which illustrates an example flowchart of a process 300 of determining resource blocks in accordance with some example embodiments of the present disclosure. FIG. 3 will be described with reference to FIG. 1A.

The scenario in FIG. 3 describes that the terminal device 102 has knowledge of the position of the UL subband, DL subband, and potential guard subband(s) in both time and frequency domain, and the terminal device 102 receives scheduling information for a DL transmission where a plurality of consecutive RBs are allocated in the RA type 1 manner. It is understood that for simplicity, the example embodiments of the present disclosure will described with the DL case thereafter, while the procedure also applies to UL scheduling by reverting the logic.

At 302, the terminal device 102 may receive information about the SBFD symbol or slot configuration such that terminal device 102 knows the split in frequency of UL and DL RBs as well as potential guardbands between UL and DL subbands. In some example embodiments, terminal device 102 may receive the allocation in terms of a RIV (Resource Indicator Value), from which the terminal device 102 may determine an initial RB (an index S) and a number of consecutive RBs (an index N). Thus, terminal device 102 may have knowledge about the first RB of the forbidden subband (an index U1) and the last RB of the forbidden subband (an index U2). The forbidden subband herein means the subband including UL subband and guardband(s) (if applicable) in SBFD slots. Thus, the terminal device 102 knows the BWP size, the starting RB of the forbidden subband (U1) and the last RB of the forbidden subband (U2). It is noted that start and initial, final and last may be used interchangeably thereafter.

At 304, the terminal device 102 may receive a PDSCH in a slot or symbol. The slot or symbol may be configured with at least one DL and UL resource. For example, the terminal device 102 is indicated to receive a PDSCH, it may receive a RIV indicating the start RB(S) and the number of RBs to be allocated (N).

At 306, the terminal device 102 may check if the initial RB(S) is within the forbidden subband. If yes, the process 300 may continue to 308. If no, the process 300 may continue to 310.

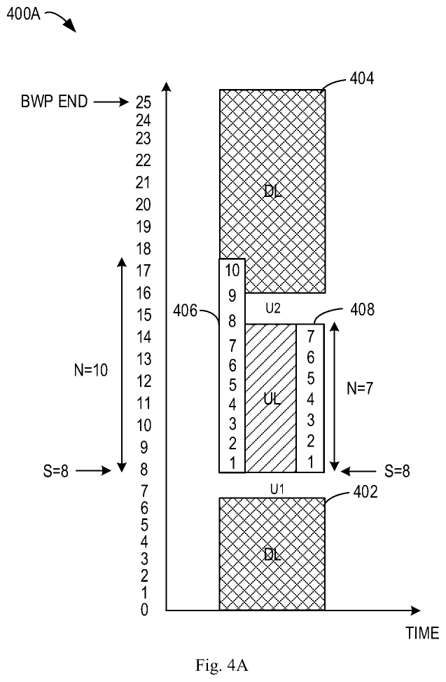

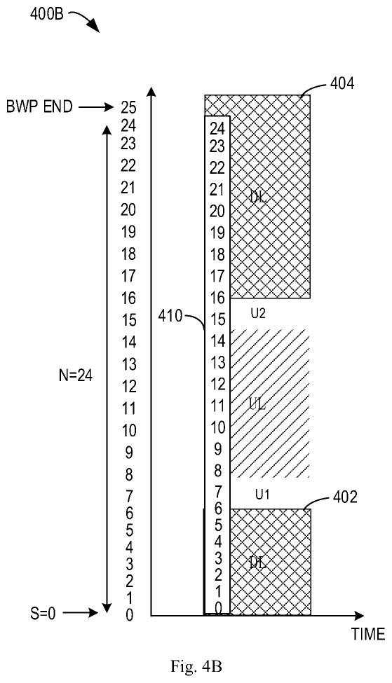

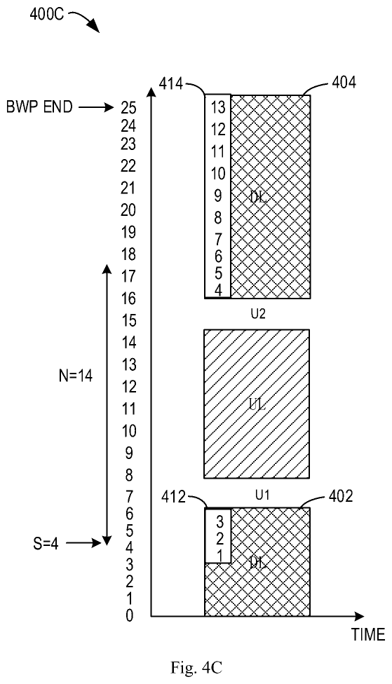

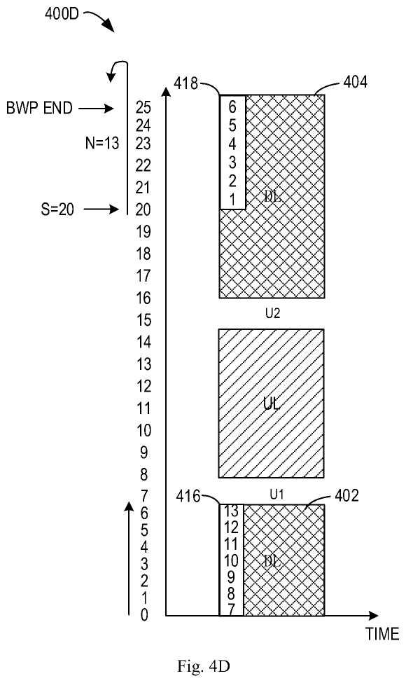

At 308, the terminal device 102 may assume that the network device 104 wants the RBs within the forbidden subband to be used. This option is shown in FIG. 4A. As shown in FIG. 4A, the initial RB (S=8) is in the forbidden subband (from U1 to U2). The number of the plurality of consecutive RBs is N=10. The final/last RB is located at 17 (S+N−1=17). In this allocation, let F represent the final RB, and thus F is calculated as F=S+N−1=17. Therefore, the terminal device 102 may use the whole area of the plurality of consecutive RBs, which are from S to F. In this case, no rate matching is applied. In some example embodiments, (i.e. if U1<=S<=U2), the terminal device 102 may assume that the allocation can overlap with the forbidden subband. For example, the terminal device 102 may consider all indicated RBs for the PDSCH allocation of the symbol of the slot or symbol to be part of the DL frequency domain resource allocation, no rate matching is applied.

As another example shown in FIG. 4A, where S=8 and N=7. In this case, the position of the final RB F is calculated as F=S+N−1=14. The terminal device 102 may also use the whole area of the plurality of consecutive RBs, which are from S=8 to F=14. In this case, no rate matching is applied.

Referring back to FIG. 3, at 310, the terminal device 102 may check the initial RB(S) and the final RB (F=S+N−1) are in the same DL subband. For example, the terminal device may check if the allocation fits in one DL subband. For example, both in the lower DL subband 402 (also referred as the first DL subband), or both in the upper DL subband 404 (also referred as the second DL subband).

If both of the initial RB and the final RB are in the same DL subband, the process 300 may continue to 308. The terminal device 102 may use the whole area of the plurality of consecutive RBs, which are from S to F. In this case, no rate matching is applied. In some example embodiments, If (S<U1 and S+N−1<U1) or (S>U2 and S+N−1<=BWP_end), the allocation is given by all RBs in the interval [S, S+N−1]. BWP_end is the index of the last RB in the BWP.

If the terminal device 102 determines the initial RB(S) and the final RB (F=S+N−1) are not in the same DL subband, the process 300 may continue to 312. At 312, the initial RB(S) and the final RB (F=S+N−1) are in different DL subbands. The terminal device may determine if S in the first DL subband. If yes, the process may continue to 314. If no, the process 300 may continue to 316.

At 314, if the number of RBs (N) does not fit the in remaining RBs in the DL subbands, and the RBs of the BWP is larger than the allocated RBs. The process may continue to 308. The terminal device may use the whole area of the plurality of consecutive RBs. For example, as shown in FIG. 4B, the initial RB S=0, and the number of RBs is N. The BWP end RB is 25. Thus, the RBs in area 410 may be used.

Referring back to FIG. 3, if the allocation does not fit the plurality of DL subbands (i.e. S<U1 and S+N−1>=U1), the process may continue to block 318. At 318, the terminal device 102 may initially calculate the final RB (as indicated by F_init) by assuming rate matching around the RBs within the forbidden subband, where F_init=S+N−1+ (U2-U1+1)=S+N+U2−U1.

In some embodiments, if F_init<=BWP_end, the terminal device 102 may not consider as valid the RBs within the forbidden subband. Instead of rate matching, the terminal device 102 may allocate the RBs within the first DL subband, from S to U1−1, and the terminal device may offset the remaining RBs in the allocation by U2−U1+1. The remaining RBs may be allocated in the second DL subband from U2+1 to S+N+U2−U1. FIG. 4C shows this case. As shown in FIG. 4C, the initial RB S=4, and the number of RBs is 13. The BWP end RB is 25. Thus, the final allocation of RBs is only in first DL subband area 412 and second DL subband area 414, and rate-matching is applied.

Referring back to FIG. 3, if F_init>BWP_end, the terminal device may assume that the allocation overlapping with the forbidden subband is valid for PDSCH reception. For example, the terminal device may assume that all indicated RBs for the PDSCH allocation of the slot or symbol to be part of the DL frequency domain resource allocation, no rate matching is applied. The final RB may finally determined as F=S+N−1, and the final allocation may be given by all RBs in the interval [S, S+N−1].

At 316, if S>U2 (i.e. the allocation starts in the upper DL subband) and the allocation does not fit one DL subband (i.e. S+N−1>BWP_end), the terminal device 102 may determine FDRA for the PDSCH in a cyclic shift manner, such as the following loop (1).

$$For j = 1 : N \qquad ( 1 )$$

$$i = mod ( S + j - 1 , {BWP}_{E n d} + 1 ) ;$$

$$End$$

The illustration of loop (1) may be referred to FIG. 4D. In FIG. 4D, the initial S=20, which is in the second DL subband, the number of RBs N=14, which exceeds the BWP. Thus, the final allocated RBs may be starting in the second PDSCH subband area 418 and continue in the first PDSCH bandband area 416.

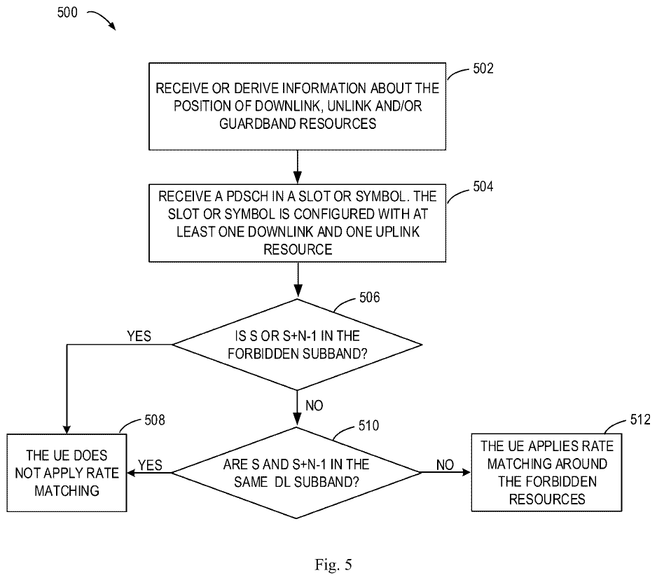

FIG. 5 illustrates another example flowchart of a process 500 of determining resource blocks in accordance with some example embodiments of the present disclosure. As shown in FIG. 5, block 502 corresponds to block 302 in FIG. 3, and block 504 corresponds to block 504 in FIG. 3. Thus, for brevity, blocks 502 and 504 will not be described herein.

At 506, the terminal device 102 may determine that if the initial RB or the final RB is in the forbidden band. If either of the initial RB S or the last RB S+N−1 is in the forbidden band, the process may continue to block 508. If neither of the initial RB or the final RB is in the forbidden band, the process may continue to 510.

At 508, the terminal device 102 may assume that the network device 104 wants the RBs within the forbidden subband to be used. The resource allocation may include all RBs from the initial RB S to the last RB S+N−1 as indicated, and thus no rate matching may be applied.

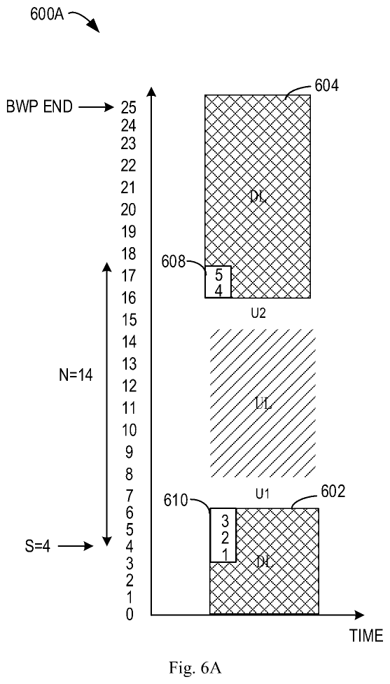

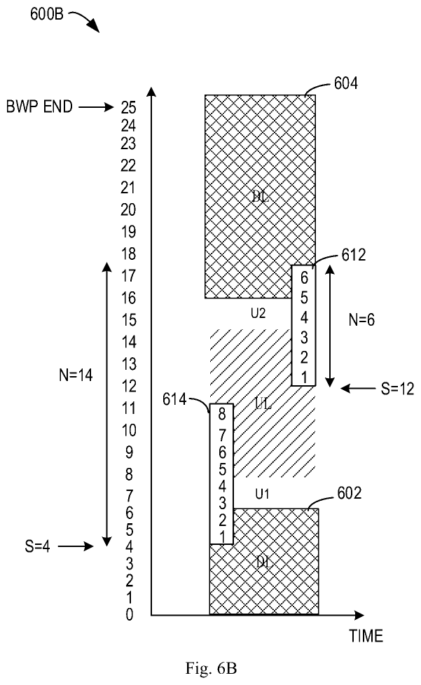

In some example embodiments, if the initial RB or the last RB is in the forbidden bands, rate matching may not be applied and the determined resource allocation is including all the consecutive RBs from the initial RB S to the last RB S+N−1. This case is shown in FIG. 6B. As shown, in one example, in block 614, the initial RB S=4, and the last RB S+N−1=11. Thus the final allocated RB is in block 614, and rate matching may not be applied as the final RB is in the forbidden band. In one example, in block 612, the initial RB S=12, and the last RB S+N−1=17. Thus the final allocated RB is in block 612, and rate matching may not be applied as the initial RB is in the forbidden band.

At 510, the terminal device 102 may determine that if both the initial RB and the final RB are in the same DL subband. If both the initial RB and the last RB are in the same DL subband, the process 500 may continue to 508. If not, the process 500 may continue to 512.

At 512, the discussion will be made with reference to as FIG. 6A. As shown in FIG. 6B, in one example, the initial S=4, which is in the first DL subband 602, the number of RBs N=14. Thus, the last RB is in the second DL subband 604. Thus, the final allocated RB set may be in only in area 610 of the first DL subband and area 608 of the second DL subband, and rate-matching around the forbidden band may be applied.

The process 500 does not allow the network device 104 to schedule a transmission where the initial and last RB are in different DL subbands and all the indicated RBs to be applied for PDSCH without rate-matching, as based on the procedures of process 500 rate-matching around the forbidden band would be applied. It is proposed a process 700 which overcomes this limitation of process 500, namely enable the network device 104 to schedule a transmission where initial RB(S) is in the lower (first) DL subband, and the last RB (S+N−1) is in the upper (second) DL subband, and no rate matching is applied around the RBs overlapping with the forbidden subband.

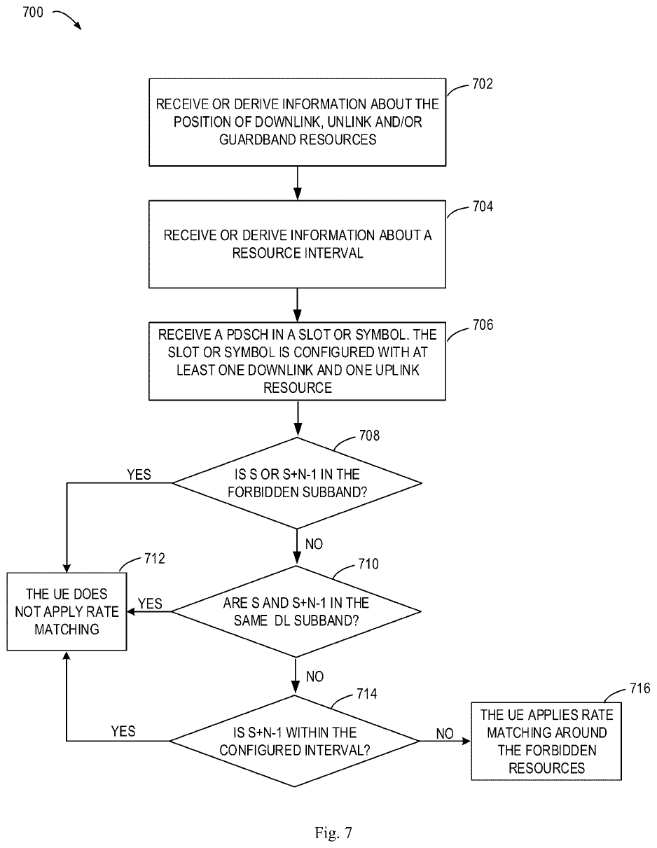

Reference is made to FIG. 7, which illustrates another example flowchart of a process 700 of determining resource blocks in accordance with some example embodiments of the present disclosure. As shown in FIG. 7, blocks 702 together correspond to block 302 in FIG. 3, and block 706 corresponds to block 306 in FIG. 3. Thus, for brevity, blocks 702 and 704 will not be described herein.

At 704, the network device 104 may configure an interval of resources. In some example embodiments, the interval may be defined in a specification. In some example embodiments, the interval may be signaled by the network device. The interval may consist of a single RB, for example, the last RB in the BWP, or a group of RBs (indicated by starting RB or last RB, by the starting RB and a length, or by a bitmap of an resource block groups).

At 708, the terminal device 102 may determine if either the initial RB(S) or the last RB (S+N−1) indicated by the RIV falls outside of any DL subband (or equivalently within any forbidden subband). If yes, the process 700 may continue to 712. If no, the process may continue to 710.

At 712, the RB allocation may be determined as indicated in the RIV and no rate-matching is applied (for example, the allocation may consist of all RBs in the interval [S, S+N−1]).

At 710, the terminal device 102 may determine if the initial RB(S) and the last RB (S+N−1) both fall in a (single) DL subband. If yes, the process may continue to 712. If not, the process may continue to 714.

At 714, the terminal device 102 may determine if the last RB (S+N−1) is within the configured interval. If yes, the process may continue to 712. If not, the process may continue to 716.

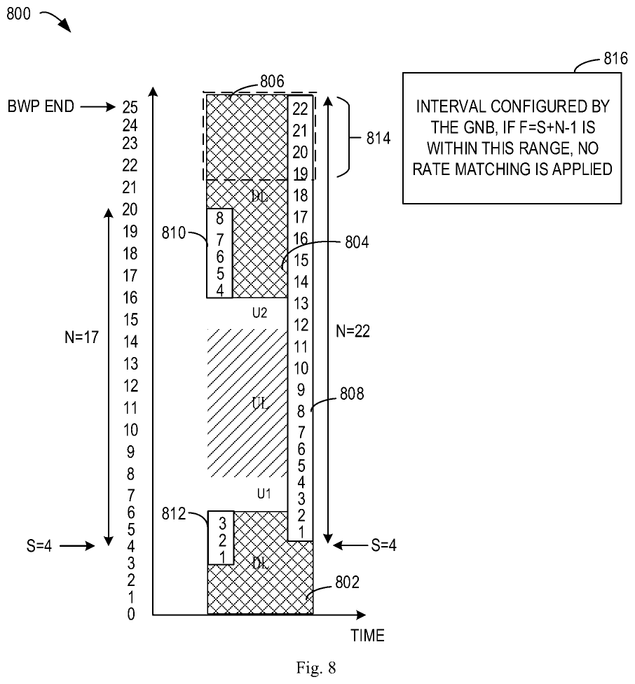

At 716, for example, the RB allocation may be rate matched around the forbidden band within the resource allocation indicated by the RIV. This case is shown in FIG. 8.

As shown in FIG. 8, the interval 814 consists of RBs 19 to 22. In one example, the initial RB S=4, the last RB S+N−1=22, so the final RB is within the interval 814. Therefore, the final RB allocation may be in area 808, which consists the whole allocated RBs. In other example, the initial RB S=4, the last RB S+N−1=20, so the last RB is not within the interval 814. Therefore, the final RB allocation may be in only in DL subbands in area 812 and area 810, and rate-matching may be applied round around the forbidden band.

By implementing the processes 300, 500 and 700, it allows to indicate to the UE whether or not to allocate DL within the UL subband and guardband(s), without additional overhead. It also provides a way of reusing existing signalling to indicate the UE that the allocation can be done in non-contiguous way, resulting in more RBs being allocated with the same signalling when compared to the rate-matching approach.

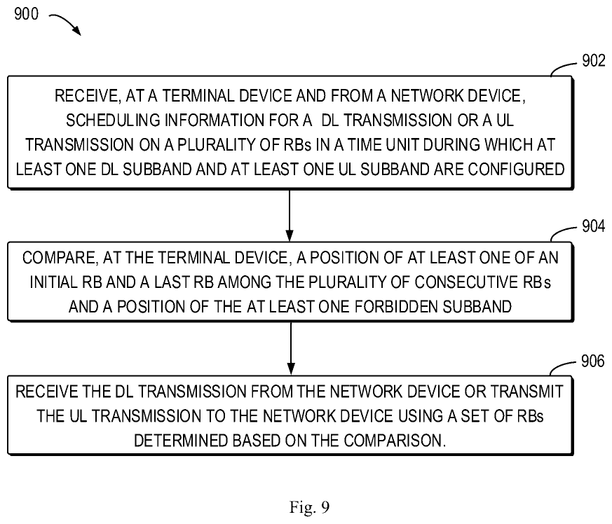

Reference is made to FIG. 9, which illustrates an example flowchart of a method 900 implemented at a terminal device in accordance with some example embodiments of the present disclosure. Reference will be made in combination with FIG. 1A. Similar, it is understood that for simplicity, the example embodiments of the present disclosure will described with the DL PDSCH case thereafter, while the procedure also applies to UL scheduling by reverting the logic.

At 902, the terminal device 102 receives, from a network device, scheduling information for a DL or a UL transmission indicating a plurality of consecutive RBs in a time unit during which at least one forbidden subband is configured for the transmission.

At 904, the terminal device 102 compares a position of at least one of an initial RB and a last RB among the plurality of consecutive RBs and a position of the at least one forbidden subband. At 906, the terminal device 102 receives the DL transmission from the network device 104 or transmits the UL transmission to the network device 104 using a set of RBs determined based on the comparison.

In some example embodiments, the terminal device 102 may transmit, based on determining that the initial RB is within the at least one forbidden subband, the DL transmission on the plurality of consecutive RBs.

In some example embodiments, the terminal device 102 may determine whether the initial RB and the last RB are within a same DL subband; and based on determining that the initial RB and the last RB are within the same DL subband, the terminal device 102 may receive the DL transmission on the plurality of consecutive RBs.

In some example embodiments, based on determining that the initial RB and the last RB are within different DL subbands or the final RB is within the at least one forbidden subband or is outside a bandwidth part (BWP) of the terminal device, the terminal device 102 may determine whether the initial RB is within the first DL subband; and based on determining that the initial RB is within the first DL subband, determine whether a sum of a first number of the plurality of consecutive RBs and a second number of RBs in the at least one forbidden subband is greater than a third number of RBs in the BWP of the terminal device; based on determining that the sum is less than or equal to the third number, receive the DL transmission on a first set of RBs and a second set of RBs, the first set of RBs comprises at least one RB among the plurality of consecutive RBs in the first DL subband, and the second set of RBs are in the second DL subband and are offset from the at least one RB among the plurality of consecutive RBs in the first DL subband by the second number of RBs in the at least one forbidden subband.

In some example embodiments, based on determining that the sum is greater than the third number, the terminal device 102 may receive the DL transmission on the plurality of consecutive RBs.

In some example embodiments, based on determining that the initial RB is within the second DL subband, the terminal device 102 may receive the DL transmission on a third set of RBs and a fourth set of RBs, and the third set of RBs comprises at least one RB among the plurality of consecutive RBs in the second DL subband, and the fourth set of RBs are in the first DL subband and are offset from at least one RB among the plurality of consecutive RBs outside the BWP by the third number of RBs in the BWP.

In some example embodiments, the terminal device 102 may determine either the initial RB or the last RB is in the at least one forbidden subband; and based on determining that the initial RB and the last RB are within the same DL subband, receive the DL transmission on the plurality of consecutive RBs.

In some example embodiments, based on determining that the initial RB and the last RB are within different DL subbands or the final RB is within the at least one forbidden subband or is outside a BWP of the terminal device, the terminal device 102 may transmit the DL transmission on a set of RBs among the plurality of consecutive RBs excluding at least one RB in the at least one forbidden subband.

In some example embodiments, based on determining that the initial RB and the last RB are within different DL subbands or the final RB is within the at least one forbidden subband or is outside a BWP of the terminal device, the terminal device 102 may determine whether the last RB is within an interval comprising at least one RB; and based on determining that the last RB is within the interval, receive the DL transmission on the plurality of consecutive RBs.

In some example embodiments, based on determining that the last RB is outside the interval, the terminal device 102 may receive the DL transmission on a set of RBs among the plurality of consecutive RBs excluding at least one RB in the at least one forbidden subband.

In some example embodiments, based on determining that the initial RB is within the at least one forbidden subband, the terminal device 102 may transmit the UL transmission on the plurality of consecutive RBs.

In some example embodiments, based on determining that the initial RB is outside the at least one forbidden subband, the terminal device 102 may determine whether the initial RB and the last RB are within a same UL subband and based on determining that the initial RB and the last RB are within the same UL subband, the terminal device 102 may transmit the UL transmission on the plurality of consecutive RBs.

In some example embodiments, based on determining that the initial RB and the last RB are within different UL subbands or the final RB is within the at least one forbidden subband or is outside a BWP of the terminal device, the terminal device 102 may determine whether the initial RB is within the first UL subband; and based on determining that the initial RB is within the first UL subband, the terminal device 102 may determine whether a sum of a first number of the plurality of consecutive RBs and a second number of RBs in the at least one forbidden subband is greater than a third number of RBs in the BWP of the terminal device; and based on determining that the sum is less than or equal to the third number, the terminal device 102 may transmit the UL transmission on a first set of RBs and a second set of RBs, and the first set of RBs comprises at least one RB among the plurality of consecutive RBs in the first UL subband, and the second set of RBs are in the second UL subband and are offset from the at least one RB among the plurality of consecutive RBs in the first UL subband by the second number of RBs in the at least one forbidden subband.

In some example embodiments, based on determining that the sum is greater than the third number, the terminal device 102 may transmit the UL transmission on the plurality of consecutive RBs.

In some example embodiments, based on determining that the initial RB is within the second UL subband, the terminal device 102 may transmit the UL transmission on a third set of RBs and a fourth set of RBs, and the third set of RBs comprises at least one RB among the plurality of consecutive RBs in the second UL subband, and the fourth set of RBs are in the first UL subband and are offset from at least one RB among the plurality of consecutive RBs outside the BWP by the third number of RBs in the BWP.

In some example embodiments, the terminal device 102 may determine either the initial RB or the last RB is in the at least one forbidden subband; and based on determining that either the initial RB or the last RB is in the at least one forbidden subband, the terminal device 102 may transmit the UL transmission on the plurality of consecutive RBs.

In some example embodiments, based on determining that neither the initial RB nor the last RB is in the at least one forbidden subband, the terminal device 102 may determine whether the initial RB and the last RB are within a same UL subband; and based on determining that the initial RB and the last RB are within the same UL subband, the terminal device 102 may transmit the UL transmission on the plurality of consecutive RBs.

In some example embodiments, based on determining that the initial RB and the last RB are within different UL subbands or the final RB is within the at least one forbidden subband or is outside a BWP of the terminal device, the terminal device 102 may transmit the UL transmission on a set of RBs among the plurality of consecutive RBs excluding at least one RB in the at least one forbidden subband.

In some example embodiments, based on determining that the initial RB and the last RB are within different UL subbands or the final RB is within the at least one forbidden subband or is outside a BWP of the terminal device, the terminal device 102 may determine whether the last RB is within an interval comprising at least one RB; and based on determining that the last RB is within the interval, the terminal device 102 may transmit the UL transmission on the plurality of consecutive RBs.

In some example embodiments, based on determining that the last RB is outside the interval, the terminal device 102 may transmit the UL transmission on a set of RBs among the plurality of consecutive RBs excluding at least one RB in the at least one forbidden subband.

In some example embodiments, the interval may be configured by the network device or predefined. In some example embodiments, the at least one forbidden subband may be configured with at least one of a UL subband or a guardband for the DL transmission, and the at least one forbidden subband may be configured with at least one of a DL subband or a guardband for the UL transmission. In some example embodiments, the time unit may comprise a slot or a symbol.

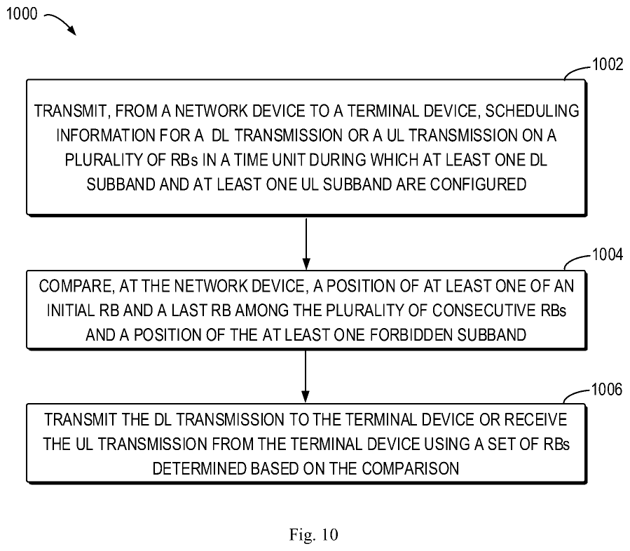

Reference is made to FIG. 10, which illustrates an example flowchart 1000 of a method implemented at a network device in accordance with some example embodiments of the present disclosure. Reference will be made in combination with FIG. 1A.

At 1002, the network device 104 transmits, to a terminal device 102, scheduling information for a DL or a UL transmission indicating a plurality of consecutive RBs in a time unit during which at least one forbidden subband is configured for the transmission.

At 1004, the network device 104 compares a position of at least one of an initial RB and a last RB among the plurality of consecutive RBs and a position of the at least one forbidden subband. At 1006, the network device 104 transmits the DL transmission to the terminal device or receives the UL transmission from the terminal device using a set of RBs determined based on the comparison.

In some example embodiments, the network device 104 may transmit, based on determining that the initial RB is within the at least one forbidden subband, the DL transmission on the plurality of consecutive RBs.

In some example embodiments, the network device 104 may determine whether the initial RB and the last RB are within a same DL subband; and based on determining that the initial RB and the last RB are within the same DL subband, the network device 104 may transmit the DL transmission on the plurality of consecutive RBs.

In some example embodiments, based on determining that the initial RB and the last RB are within different DL subbands or the final RB is within the at least one forbidden subband or is outside a bandwidth part (BWP) of the terminal device, the network device 104 may determine whether the initial RB is within the first DL subband; and based on determining that the initial RB is within the first DL subband, determine whether a sum of a first number of the plurality of consecutive RBs and a second number of RBs in the at least one forbidden subband is greater than a third number of RBs in the BWP of the terminal device; based on determining that the sum is less than or equal to the third number, transmit the DL transmission on a first set of RBs and a second set of RBs, the first set of RBs comprises at least one RB among the plurality of consecutive RBs in the first DL subband, and the second set of RBs are in the second DL subband and are offset from the at least one RB among the plurality of consecutive RBs in the first DL subband by the second number of RBs in the at least one forbidden subband.

In some example embodiments, based on determining that the sum is greater than the third number, the network device 104 may transmit the DL transmission on the plurality of consecutive RBs.

In some example embodiments, based on determining that the initial RB is within the second DL subband, the network device 104 may transmit the DL transmission on a third set of RBs and a fourth set of RBs, and the third set of RBs comprises at least one RB among the plurality of consecutive RBs in the second DL subband, and the fourth set of RBs are in the first DL subband and are offset from at least one RB among the plurality of consecutive RBs outside the BWP by the third number of RBs in the BWP.

In some example embodiments, the network device 104 may determine either the initial RB or the last RB is in the at least one forbidden subband; and based on determining that the initial RB and the last RB are within the same DL subband, transmit the DL transmission on the plurality of consecutive RBs.

In some example embodiments, based on determining that the initial RB and the last RB are within different DL subbands or the final RB is within the at least one forbidden subband or is outside a BWP of the terminal device, the network device 104 may transmit the DL transmission on a set of RBs among the plurality of consecutive RBs excluding at least one RB in the at least one forbidden subband.

In some example embodiments, based on determining that the initial RB and the last RB are within different DL subbands or the final RB is within the at least one forbidden subband or is outside a BWP of the terminal device, the network device 104 may determine whether the last RB is within an interval comprising at least one RB; and based on determining that the last RB is within the interval, transmit the DL transmission on the plurality of consecutive RBs.

In some example embodiments, based on determining that the last RB is outside the interval, the network device 104 may transmit the DL transmission on a set of RBs among the plurality of consecutive RBs excluding at least one RB in the at least one forbidden subband.

In some example embodiments, based on determining that the initial RB is within the at least one forbidden subband, the network device 104 may receive the UL transmission on the plurality of consecutive RBs.

In some example embodiments, based on determining that the initial RB is outside the at least one forbidden subband, the network device 104 may determine whether the initial RB and the last RB are within a same UL subband and the network device 104 may based on determining that the initial RB and the last RB are within the same UL subband, receive the UL transmission on the plurality of consecutive RBs.

In some example embodiments, based on determining that the initial RB and the last RB are within different UL subbands or the final RB is within the at least one forbidden subband or is outside a BWP of the terminal device, the network device 104 may determine whether the initial RB is within the first UL subband; and based on determining that the initial RB is within the first UL subband, the network device 104 may determine whether a sum of a first number of the plurality of consecutive RBs and a second number of RBs in the at least one forbidden subband is greater than a third number of RBs in the BWP of the terminal device; and based on determining that the sum is less than or equal to the third number, the network device 104 may receive the UL transmission on a first set of RBs and a second set of RBs, and the first set of RBs comprises at least one RB among the plurality of consecutive RBs in the first UL subband, and the second set of RBs are in the second UL subband and are offset from the at least one RB among the plurality of consecutive RBs in the first UL subband by the second number of RBs in the at least one forbidden subband.

In some example embodiments, based on determining that the sum is greater than the third number, the network device 104 may receive the UL transmission on the plurality of consecutive RBs.

In some example embodiments, based on determining that the initial RB is within the second UL subband, the network device 104 may receive the UL transmission on a third set of RBs and a fourth set of RBs, and the third set of RBs comprises at least one RB among the plurality of consecutive RBs in the second UL subband, and the fourth set of RBs are in the first UL subband and are offset from at least one RB among the plurality of consecutive RBs outside the BWP by the third number of RBs in the BWP.

In some example embodiments, the network device 104 may determine either the initial RB or the last RB is in the at least one forbidden subband; and based on determining that either the initial RB or the last RB is in the at least one forbidden subband, the network device 104 may receive the UL transmission on the plurality of consecutive RBs.

In some example embodiments, based on determining that neither the initial RB nor the last RB is in the at least one forbidden subband, the network device 104 may determine whether the initial RB and the last RB are within a same UL subband; and based on determining that the initial RB and the last RB are within the same UL subband, the network device 104 may receive the UL transmission on the plurality of consecutive RBs.

In some example embodiments, based on determining that the initial RB and the last RB are within different UL subbands or the final RB is within the at least one forbidden subband or is outside a BWP of the terminal device, the network device 104 may receive the UL transmission on a set of RBs among the plurality of consecutive RBs excluding at least one RB in the at least one forbidden subband.

In some example embodiments, based on determining that the initial RB and the last RB are within different UL subbands or the final RB is within the at least one forbidden subband or is outside a BWP of the terminal device, the network device 104 may determine whether the last RB is within an interval comprising at least one RB; and based on determining that the last RB is within the interval, the network device 104 may receive the UL transmission on the plurality of consecutive RBs.

In some example embodiments, based on determining that the last RB is outside the interval, the network device 104 may receive the UL transmission on a set of RBs among the plurality of consecutive RBs excluding at least one RB in the at least one forbidden subband.

In some example embodiments, the interval may be configured by the network device or predefined. In some example embodiments, the at least one forbidden subband may be configured with at least one of a UL subband or a guardband for the DL transmission, and the at least one forbidden subband may be configured with at least one of a DL subband or a guardband for the UL transmission. In some example embodiments, the time unit may comprise a slot or a symbol.

By implementing the methods 900 and 1000, the example embodiments for RB determining can allow to indicate to the UE whether or not to allocate DL within the UL subband and guardband(s), without additional overhead. It also provides a way of reusing existing signalling to indicate the UE that the allocation can be done in non-contiguous way, resulting in more RBs being allocated with the same signalling when compared to the rate-matching approach.

In some example embodiments, an apparatus capable of performing the method 900 (for example, the terminal device 102) may comprise means for performing the respective steps of the method 900. The means may be implemented in any suitable form. For example, the means may be implemented in a circuitry or software module.

In some example embodiments, the apparatus may comprise: means for receiving, at a terminal device and from a network device, scheduling information for a DL or a UL transmission indicating a plurality of consecutive RBs in a time unit during which at least one forbidden subband is configured for the transmission; means for comparing a position of at least one of an initial RB and a last RB among the plurality of consecutive RBs and a position of the at least one forbidden subband; and means for receiving the DL transmission from the network device or transmitting the UL transmission to the network device using a set of RBs determined based on the comparison.

In some example embodiments, the apparatus may comprise means for receiving the DL transmission based on determining that the initial RB is within the at least one forbidden subband, receiving the DL transmission on the plurality of consecutive RBs.

In some example embodiments, the apparatus may comprise means for receiving the DL transmission based on determining that the initial RB is outside the at least one forbidden subband, determining whether the initial RB and the last RB are within a same DL subband; and means for based on determining that the initial RB and the last RB are within the same DL subband, receiving the DL transmission on the plurality of consecutive RBs.

In some example embodiments, the apparatus may comprise means for based on determining that the initial RB and the last RB are within different DL subbands or the final RB is within the at least one forbidden subband or is outside a bandwidth part (BWP) of the terminal device, determining whether the initial RB is within the first DL subband; and means for based on determining that the initial RB is within the first DL subband, determining whether a sum of a first number of the plurality of consecutive RBs and a second number of RBs in the at least one forbidden subband is greater than a third number of RBs in the BWP of the terminal device; and means for based on determining that the sum is less than or equal to the third number, receiving the DL transmission on a first set of RBs and a second set of RBs, wherein the first set of RBs comprises at least one RB among the plurality of consecutive RBs in the first DL subband, and the second set of RBs are in the second DL subband and are offset from the at least one RB among the plurality of consecutive RBs in the first DL subband by the second number of RBs in the at least one forbidden subband.

In some example embodiments, the apparatus may comprise means for based on determining that the sum is greater than the third number, receiving the DL transmission on the plurality of consecutive RBs.

In some example embodiments, the apparatus may comprise means for based on determining that the initial RB is within the second DL subband, receiving the DL transmission on a third set of RBs and a fourth set of RBs, wherein the third set of RBs comprises at least one RB among the plurality of consecutive RBs in the second DL subband, and wherein the fourth set of RBs are in the first DL subband and are offset from at least one RB among the plurality of consecutive RBs outside the BWP by the third number of RBs in the BWP.

In some example embodiments, the apparatus may comprise means for determining either the initial RB or the last RB is in the at least one forbidden subband; and means for based on determining that the initial RB and the last RB are within the same DL subband, receiving the DL transmission on the plurality of consecutive RBs.

In some example embodiments, the apparatus may comprise means for based on determining that the initial RB and the last RB are within different DL subbands or the final RB is within the at least one forbidden subband or is outside a BWP of the terminal device, receiving the DL transmission on a set of RBs among the plurality of consecutive RBs excluding at least one RB in the at least one forbidden subband.

In some example embodiments, the apparatus may comprise means for based on determining that the initial RB and the last RB are within different DL subbands or the final RB is within the at least one forbidden subband or is outside a BWP of the terminal device, determining whether the last RB is within an interval comprising at least one RB; and means for based on determining that the last RB is within the interval, receiving the DL transmission on the plurality of consecutive RBs.

In some example embodiments, the apparatus may comprise means for based on determining that the last RB is outside the interval, receiving the DL transmission on a set of RBs among the plurality of consecutive RBs excluding at least one RB in the at least one forbidden subband.

In some example embodiments, the apparatus may comprise means for based on determining that the initial RB is within the at least one forbidden subband, transmitting the UL transmission on the plurality of consecutive RBs.

In some example embodiments, the apparatus may comprise means for based on determining that the initial RB is outside the at least one forbidden subband, determining whether the initial RB and the last RB are within a same UL subband; and means for based on determining that the initial RB and the last RB are within the same UL subband, transmitting the UL transmission on the plurality of consecutive RBs.

In some example embodiments, the apparatus may comprise means for based on determining that the initial RB and the last RB are within different UL subbands or the final RB is within the at least one forbidden subband or is outside a BWP of the terminal device, determining whether the initial RB is within the first UL subband; and means for based on determining that the initial RB is within the first UL subband, determining whether a sum of a first number of the plurality of consecutive RBs and a second number of RBs in the at least one forbidden subband is greater than a third number of RBs in the BWP of the terminal device; and means for based on determining that the sum is less than or equal to the third number, transmitting the UL transmission on a first set of RBs and a second set of RBs, wherein the first set of RBs comprises at least one RB among the plurality of consecutive RBs in the first UL subband, and the second set of RBs are in the second UL subband and are offset from the at least one RB among the plurality of consecutive RBs in the first UL subband by the second number of RBs in the at least one forbidden subband.

In some example embodiments, the apparatus may comprise means for based on determining that the sum is greater than the third number, transmitting the UL transmission on the plurality of consecutive RBs.

In some example embodiments, the apparatus may comprise means for based on determining that the initial RB is within the second UL subband, receiving the UL transmission on a third set of RBs and a fourth set of RBs, wherein the third set of RBs comprises at least one RB among the plurality of consecutive RBs in the second UL subband, and wherein the fourth set of RBs are in the first UL subband and are offset from at least one RB among the plurality of consecutive RBs outside the BWP by the third number of RBs in the BWP.

In some example embodiments, the apparatus may comprise means for determining either the initial RB or the last RB is in the at least one forbidden subband; and means for based on determining that either the initial RB or the last RB is in the at least one forbidden subband, transmitting the UL transmission on the plurality of consecutive RBs.

In some example embodiments, the apparatus may comprise means for based on determining that neither the initial RB nor the last RB is in the at least one forbidden subband, determining whether the initial RB and the last RB are within a same UL subband; and means for based on determining that the initial RB and the last RB are within the same UL subband, transmitting the UL transmission on the plurality of consecutive RBs.

In some example embodiments, the apparatus may comprise means for based on determining that the initial RB and the last RB are within different UL subbands or the final RB is within the at least one forbidden subband or is outside a BWP of the terminal device, transmitting the UL transmission on a set of RBs among the plurality of consecutive RBs excluding at least one RB in the at least one forbidden subband.

In some example embodiments, the apparatus may comprise means for based on determining that the initial RB and the last RB are within different UL subbands or the final RB is within the at least one forbidden subband or is outside a BWP of the terminal device, determining whether the last RB is within an interval comprising at least one RB; and means for based on determining that the last RB is within the interval, transmitting the UL transmission on the plurality of consecutive RBs.

In some example embodiments, the apparatus may comprise means for based on determining that the last RB is outside the interval, transmitting the UL transmission on a set of RBs among the plurality of consecutive RBs excluding at least one RB in the at least one forbidden subband.

In some example embodiments, the interval may be configured by the network device or predefined. In some example embodiments, the at least one forbidden subband may be configured with at least one of a UL subband or a guardband for the DL transmission, and the at least one forbidden subband may be configured with at least one of a DL subband or a guardband for the UL transmission. In some example embodiments, the time unit may comprise a slot or a symbol.

In some embodiments, the apparatus may further comprise means for performing other steps in some embodiments of the method 900. In some embodiments, the means comprises at least one processor and at least one memory including computer program code, the at least one memory and computer program code configured to, with the at least one processor, cause the performance of the apparatus.

In some example embodiments, an apparatus capable of performing the method 1000 (for example, the network device 104) may comprise means for performing the respective steps of the method 1000. The means may be implemented in any suitable form. For example, the means may be implemented in a circuitry or software module.

In some example embodiments, The apparatus may comprise: means for transmitting, at a network device and to a terminal device, scheduling information for a DL or a UL transmission indicating a plurality of consecutive RBs in a time unit during which at least one forbidden subband is configured for the transmission; means for comparing a position of at least one of an initial RB and a last RB among the plurality of consecutive RBs and a position of the at least one forbidden subband; and means for transmitting the DL transmission to the terminal device or receiving the UL transmission from the terminal device using a set of RBs determined based on the comparison.

In some example embodiments, the apparatus may comprise means for transmitting the DL transmission based on determining that the initial RB is within the at least one forbidden subband, transmitting the DL transmission on the plurality of consecutive RBs.

In some example embodiments, the apparatus may comprise means for transmitting the DL transmission based on determining that the initial RB is outside the at least one forbidden subband, determining whether the initial RB and the last RB are within a same DL subband; and means for based on determining that the initial RB and the last RB are within the same DL subband, transmitting the DL transmission on the plurality of consecutive RBs.

In some example embodiments, the apparatus may comprise means for based on determining that the initial RB and the last RB are within different DL subbands or the final RB is within the at least one forbidden subband or is outside a bandwidth part (BWP) of the terminal device, determining whether the initial RB is within the first DL subband; and means for based on determining that the initial RB is within the first DL subband, determining whether a sum of a first number of the plurality of consecutive RBs and a second number of RBs in the at least one forbidden subband is greater than a third number of RBs in the BWP of the terminal device; and means for based on determining that the sum is less than or equal to the third number, transmitting the DL transmission on a first set of RBs and a second set of RBs, wherein the first set of RBs comprises at least one RB among the plurality of consecutive RBs in the first DL subband, and the second set of RBs are in the second DL subband and are offset from the at least one RB among the plurality of consecutive RBs in the first DL subband by the second number of RBs in the at least one forbidden subband.

In some example embodiments, the apparatus may comprise means for based on determining that the sum is greater than the third number, transmitting the DL transmission on the plurality of consecutive RBs.

In some example embodiments, the apparatus may comprise means for based on determining that the initial RB is within the second DL subband, transmitting the DL transmission on a third set of RBs and a fourth set of RBs, wherein the third set of RBs comprises at least one RB among the plurality of consecutive RBs in the second DL subband, and wherein the fourth set of RBs are in the first DL subband and are offset from at least one RB among the plurality of consecutive RBs outside the BWP by the third number of RBs in the BWP.

In some example embodiments, the apparatus may comprise means for determining either the initial RB or the last RB is in the at least one forbidden subband; and means for based on determining that the initial RB and the last RB are within the same DL subband, transmitting the DL transmission on the plurality of consecutive RBs.

In some example embodiments, the apparatus may comprise means for based on determining that the initial RB and the last RB are within different DL subbands or the final RB is within the at least one forbidden subband or is outside a BWP of the terminal device, transmitting the DL transmission on a set of RBs among the plurality of consecutive RBs excluding at least one RB in the at least one forbidden subband.

In some example embodiments, the apparatus may comprise means for based on determining that the initial RB and the last RB are within different DL subbands or the final RB is within the at least one forbidden subband or is outside a BWP of the terminal device, determining whether the last RB is within an interval comprising at least one RB; and means for based on determining that the last RB is within the interval, transmitting the DL transmission on the plurality of consecutive RBs.

In some example embodiments, the apparatus may comprise means for based on determining that the last RB is outside the interval, transmitting the DL transmission on a set of RBs among the plurality of consecutive RBs excluding at least one RB in the at least one forbidden subband.

In some example embodiments, the apparatus may comprise means for based on determining that the initial RB is within the at least one forbidden subband, receiving the UL transmission on the plurality of consecutive RBs.

In some example embodiments, the apparatus may comprise means for based on determining that the initial RB is outside the at least one forbidden subband, determining whether the initial RB and the last RB are within a same UL subband; and means for based on determining that the initial RB and the last RB are within the same UL subband, receiving the UL transmission on the plurality of consecutive RBs.

In some example embodiments, the apparatus may comprise means for based on determining that the initial RB and the last RB are within different UL subbands or the final RB is within the at least one forbidden subband or is outside a BWP of the terminal device, determining whether the initial RB is within the first UL subband; and means for based on determining that the initial RB is within the first UL subband, determining whether a sum of a first number of the plurality of consecutive RBs and a second number of RBs in the at least one forbidden subband is greater than a third number of RBs in the BWP of the terminal device; and means for based on determining that the sum is less than or equal to the third number, receiving the UL transmission on a first set of RBs and a second set of RBs, wherein the first set of RBs comprises at least one RB among the plurality of consecutive RBs in the first UL subband, and the second set of RBs are in the second UL subband and are offset from the at least one RB among the plurality of consecutive RBs in the first UL subband by the second number of RBs in the at least one forbidden subband.

In some example embodiments, the apparatus may comprise means for based on determining that the sum is greater than the third number, receiving the UL transmission on the plurality of consecutive RBs.

In some example embodiments, the apparatus may comprise means for based on determining that the initial RB is within the second UL subband, receiving the UL transmission on a third set of RBs and a fourth set of RBs, wherein the third set of RBs comprises at least one RB among the plurality of consecutive RBs in the second UL subband, and wherein the fourth set of RBs are in the first UL subband and are offset from at least one RB among the plurality of consecutive RBs outside the BWP by the third number of RBs in the BWP.

In some example embodiments, the apparatus may comprise means for determining either the initial RB or the last RB is in the at least one forbidden subband; and means for based on determining that either the initial RB or the last RB is in the at least one forbidden subband, receiving the UL transmission on the plurality of consecutive RBs.

In some example embodiments, the apparatus may comprise means for based on determining that neither the initial RB nor the last RB is in the at least one forbidden subband, determining whether the initial RB and the last RB are within a same UL subband; and means for based on determining that the initial RB and the last RB are within the same UL subband, receiving the UL transmission on the plurality of consecutive RBs.

In some example embodiments, the apparatus may comprise means for based on determining that the initial RB and the last RB are within different UL subbands or the final RB is within the at least one forbidden subband or is outside a BWP of the terminal device, receiving the UL transmission on a set of RBs among the plurality of consecutive RBs excluding at least one RB in the at least one forbidden subband.

In some example embodiments, the apparatus may comprise means for based on determining that the initial RB and the last RB are within different UL subbands or the final RB is within the at least one forbidden subband or is outside a BWP of the terminal device, determining whether the last RB is within an interval comprising at least one RB; and means for based on determining that the last RB is within the interval, receiving the UL transmission on the plurality of consecutive RBs.

In some example embodiments, the apparatus may comprise means for based on determining that the last RB is outside the interval, receiving the UL transmission on a set of RBs among the plurality of consecutive RBs excluding at least one RB in the at least one forbidden subband.

In some example embodiments, the interval may be configured by the network device or predefined. In some example embodiments, the at least one forbidden subband may be configured with at least one of a UL subband or a guardband for the DL transmission, and the at least one forbidden subband may be configured with at least one of a DL subband or a guardband for the UL transmission. In some example embodiments, the time unit may comprise a slot or a symbol.

In some embodiments, the apparatus may further comprise means for performing other steps in some embodiments of the method 1000. In some embodiments, the means comprises at least one processor and at least one memory including computer program code, the at least one memory and computer program code configured to, with the at least one processor, cause the performance of the apparatus.

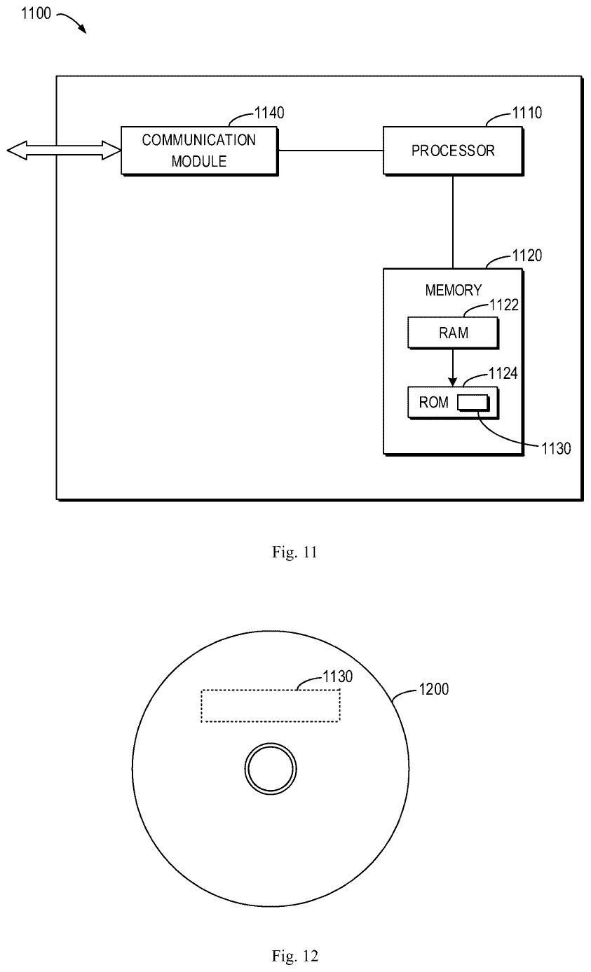

Reference is made to FIG. 11, which illustrates an example simplified block diagram of a device that is suitable for implementing embodiments of the present disclosure. The device 1100 may be provided to implement the communication device, for example the terminal device 102 as shown in FIG. 1A. As shown, the device 1100 includes one or more processors 1110, one or more memories 1120 may couple to the processor 1110, and one or more communication modules 1140 may couple to the processor 1110.

The communication module 1140 is for bidirectional communications. The communication module 1140 has at least one antenna to facilitate communication. The communication interface may represent any interface that is necessary for communication with other network elements, for example the communication interface may be wireless or wireline to other network elements, or software based interface for communication.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a read only memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program so that the device 1100 may perform any process of the disclosure as discussed with reference to FIGS. 2, 3, 7 and 7. The embodiments of the present disclosure may also be implemented by hardware or by a combination of software and hardware.

In some embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 in form of CD or DVD. The computer readable medium has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 900 or 1000 as described above with reference to FIG. 9 or FIG. 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, scheduling information for a downlink (DL) or an uplink (UL) transmission indicating a plurality of consecutive resource blocks (RBs) in a time unit during which at least one forbidden subband is configured for the transmission;
compare a position of at least one of an initial RB and a last RB among the plurality of consecutive RBs and a position of the at least one forbidden subband; and
receive the DL transmission from the network device or transmit the UL transmission to the network device using a set of RBs determined based on the comparison.

2. The terminal device of claim 1, wherein the terminal device is caused to receive the DL transmission
based on determining that the initial RB is within the at least one forbidden subband, receiving the DL transmission on the plurality of consecutive RBs.

3. The terminal device of claim 1, wherein the terminal device is caused to receive the DL transmission
based on determining that the initial RB is outside the at least one forbidden subband, determining whether the initial RB and the last RB are within a same DL subband; and
based on determining that the initial RB and the last RB are within the same DL subband, receiving the DL transmission on the plurality of consecutive RBs.

4. The terminal device of claim 3, wherein the terminal device is further caused to receive the DL transmission
based on determining that the initial RB and the last RB are within different DL subbands or the final RB is within the at least one forbidden subband or is outside a bandwidth part (BWP) of the terminal device, determining whether the initial RB is within the first DL subband;
based on determining that the initial RB is within the first DL subband, determining whether a sum of a first number of the plurality of consecutive RBs and a second number of RBs in the at least one forbidden subband is greater than a third number of RBs in the BWP of the terminal device; and
based on determining that the sum is less than or equal to the third number, receiving the DL transmission on a first set of RBs and a second set of RBs, wherein the first set of RBs comprises at least one RB among the plurality of consecutive RBs in the first DL subband, and the second set of RBs are in the second DL subband and are offset from the at least one RB among the plurality of consecutive RBs in the first DL subband by the second number of RBs in the at least one forbidden subband.

5. The terminal device of claim 4, wherein the terminal device is further caused to receive the DL transmission
based on determining that the sum is greater than the third number, receiving the DL transmission on the plurality of consecutive RBs.

6. The terminal device of claim 4, wherein the terminal device is further caused to receive the DL transmission
based on determining that the initial RB is within the second DL subband, receiving the DL transmission on a third set of RBs and a fourth set of RBs,
wherein the third set of RBs comprises at least one RB among the plurality of consecutive RBs in the second DL subband, and
wherein the fourth set of RBs are in the first DL subband and are offset from at least one RB among the plurality of consecutive RBs outside the BWP by the third number of RBs in the BWP.

7. The terminal device of claim 1, wherein the terminal device is caused to receive the DL transmission
determining either the initial RB or the last RB is in the at least one forbidden subband; and
based on determining that either the initial RB or the last RB is in the at least one forbidden subband, receiving the DL transmission on the plurality of consecutive RBs.

8. The terminal device of claim 7, wherein the terminal device is caused to receive the DL transmission
based on determining that neither the initial RB nor the last RB is in the at least one forbidden subband, determining whether the initial RB and the last RB are within a same DL subband; and
based on determining that the initial RB and the last RB are within the same DL subband, receiving the DL transmission on the plurality of consecutive RBs.

9. The terminal device of claim 8, wherein the terminal device is caused to receive the DL transmission
based on determining that the initial RB and the last RB are within different DL subbands or the final RB is within the at least one forbidden subband or is outside a BWP of the terminal device, receiving the DL transmission on a set of RBs among the plurality of consecutive RBs excluding at least one RB in the at least one forbidden subband.

10. The terminal device of claim 8, wherein the terminal device is caused to receive the DL transmission
based on determining that the initial RB and the last RB are within different DL subbands or the final RB is within the at least one forbidden subband or is outside a BWP of the terminal device, determining whether the last RB is within an interval comprising at least one RB; and
based on determining that the last RB is within the interval, receiving the DL transmission on the plurality of consecutive RBs.

11. The terminal device of claim 10, wherein the terminal device is further caused to receive the DL transmission
based on determining that the last RB is outside the interval, receiving the DL transmission on a set of RBs among the plurality of consecutive RBs excluding at least one RB in the at least one forbidden subband.

12. The terminal device of claim 1, wherein the terminal device is caused to transmit the UL transmission
based on determining that the initial RB is within the at least one forbidden subband, transmitting the UL transmission on the plurality of consecutive RBs.

13. The terminal device of claim 1, wherein the terminal device is caused to transmit the UL transmission
based on determining that the initial RB is outside the at least one forbidden subband, determining whether the initial RB and the last RB are within a same UL subband; and
based on determining that the initial RB and the last RB are within the same UL subband, transmitting the UL transmission on the plurality of consecutive RBs.

14. The terminal device of claim 13, wherein the terminal device is further caused to transmit the UL transmission
based on determining that the initial RB and the last RB are within different UL subbands or the final RB is within the at least one forbidden subband or is outside a BWP of the terminal device, determining whether the initial RB is within the first UL subband;
based on determining that the initial RB is within the first UL subband, determining whether a sum of a first number of the plurality of consecutive RBs and a second number of RBs in the at least one forbidden subband is greater than a third number of RBs in the BWP of the terminal device; and
based on determining that the sum is less than or equal to the third number, transmitting the UL transmission on a first set of RBs and a second set of RBs, wherein the first set of RBs comprises at least one RB among the plurality of consecutive RBs in the first UL subband, and the second set of RBs are in the second UL subband and are offset from the at least one RB among the plurality of consecutive RBs in the first UL subband by the second number of RBs in the at least one forbidden subband.

15. The terminal device of claim 14, wherein the terminal device is further caused to transmit the UL transmission
based on determining that the sum is greater than the third number, transmitting the UL transmission on the plurality of consecutive RBs.

16. The terminal device of claim 14, wherein the terminal device is further caused to transmit the UL transmission
based on determining that the initial RB is within the second UL subband, receiving the UL transmission on a third set of RBs and a fourth set of RBs,
wherein the third set of RBs comprises at least one RB among the plurality of consecutive RBs in the second UL subband, and
wherein the fourth set of RBs are in the first UL subband and are offset from at least one RB among the plurality of consecutive RBs outside the BWP by the third number of RBs in the BWP.

17. The terminal device of claim 1, wherein the terminal device is caused to transmit the UL transmission
determining either the initial RB or the last RB is in the at least one forbidden subband; and
based on determining that either the initial RB or the last RB is in the at least one forbidden subband, transmitting the UL transmission on the plurality of consecutive RBs.

18. The terminal device of claim 17, wherein the terminal device is caused to transmit the UL transmission
based on determining that neither the initial RB nor the last RB is in the at least one forbidden subband, determining whether the initial RB and the last RB are within a same UL subband; and
based on determining that the initial RB and the last RB are within the same UL subband, transmitting the UL transmission on the plurality of consecutive RBs.

19. The terminal device of claim 18, wherein the terminal device is caused to transmit the UL transmission
based on determining that the initial RB and the last RB are within different UL subbands or the final RB is within the at least one forbidden subband or is outside a BWP of the terminal device, transmitting the UL transmission on a set of RBs among the plurality of consecutive RBs excluding at least one RB in the at least one forbidden subband.

20. The terminal device of claim 18, wherein the terminal device is caused to transmit the UL transmission
based on determining that the initial RB and the last RB are within different UL subbands or the final RB is within the at least one forbidden subband or is outside a BWP of the terminal device, determining whether the last RB is within an interval comprising at least one RB; and
based on determining that the last RB is within the interval, transmitting the UL transmission on the plurality of consecutive RBs.

21-51. (canceled)
